(19) United States
(12) Patent Application Publication
(10) Pub. No.: US 2006/0260691 A1
(43) Pub. Date: Nov. 23, 2006

(54) Systems and methods for detecting and preventing fluid leaks

(76) Inventor: John Andrew Davidoff, Phoenix, AZ (US)

Correspondence Address: Jodi L. Hartman;Hope Baldauff Hartman, LLC, P.O. Box 2825, Atlanta, GA, 30301, US

(21) Appl. No.: 11/133,737

(22) Filed: May 20, 2005

(51) Int. Cl. G05D 7/06

(52) U.S. Cl. 137/487.5

(57) ABSTRACT

Systems and methods are provided for detecting and preventing fluid leaks. A rate of flow of a fluid through a conduit over a period of time is monitored. A determination is made whether the rate of flow of the fluid over the period of time indicates a leak in the conduit. If the rate of flow of the fluid over the period of time indicates a leak, then the flow of the liquid through the conduit is stopped, and a determination is made whether the pressure in the conduit indicates a pressure drop. If the pressure in the conduit indicates a pressure drop, then an indication is provided that a leak has been detected.

### FIELD OF THE INVENTION

The present invention relates generally to detecting and preventing fluid leaks, more particularly, to detecting unwanted fluid flow through a conduit and stopping the unwanted fluid flow.

### BACKGROUND OF THE INVENTION

Unwanted water consumption caused by leaks in a pipe system, component failure, or a tap mistakenly left on must be detected to avoid extensive damage and cost. Unchecked amounts of water leaking into a home, office, or other similar building can cause damage to furniture, clothing, woodwork, artwork and other articles in the structure including damage to the structure itself. Moreover, water leaking into a structure can cause mold to grow in and around walls and floors, which can cause serious medical problems to individuals exposed to the mold for an extended period of time.

Currently available leak detection devices are capable of detecting potentially unwanted water consumption events. However, these leak detection devices are not capable of verifying whether the detected water consumption event is actually unwanted. Thus, these devices produce a number of false alarms. False alarms can be a nuisance to homeowners because false alarms may cause unnecessary shut off of water supply and unnecessary repair trips by maintenance personnel.

Moreover, many commercially available leak detection devices are unable to modify the types of events that are detected as unwanted water consumption events based on water usage of a particular residence. Instead, the detection devices use constant, preset parameters to determine whether a leak exists, without providing means for supplementing these parameters based on specific water usage of a particular residence.

It is with respect to these considerations and others that the present invention has been made.

### SUMMARY OF THE INVENTION

In accordance with the present invention, the above and other problems are solved by systems and methods for detecting and prevention fluid leaks.

According to the method, a rate of flow of a fluid through a conduit over a period of time is monitored. A determination is made whether the rate of flow of the fluid over the period of time indicates a leak in the conduit. If the rate of flow of the fluid over the period of time indicates a leak, then the flow of the liquid through the conduit is stopped, and a determination is made whether the pressure in the conduit indicates a pressure drop. If the pressure in the conduit indicates a pressure drop, then an indication is provided that a leak has been detected.

The rate of flow of the fluid over the period of time may be compared to a list of events to determine if the rate of flow of the fluid over the period of time indicates a leak in the conduit. If the rate of flow over the period of time does not match one of the events on the list of events, then the flow of the fluid through the conduit is stopped. The list of events includes rates of flow of a fluid over periods of time corresponding to water consumption events which may include washing clothes, washing dishes, taking a shower, taking a bath, and flushing a toilet.

In accordance with another embodiment, the rate of flow of the fluid over the period of time may also be compared to a rate of flow of a fluid over a period of time corresponding to a selected operation mode to determine if the rate of flow of the fluid over the period of time indicates a leak in the conduit. The operation mode includes unique water consumption events, such as filling a pool. If the rate of flow of the liquid over the period of time does not match one of the events on the list of events or the rate of flow of the fluid over the period of time corresponding to the selected operation mode, then the flow of the fluid through the conduit is stopped.

The method may further include receiving an indication that the rate of flow of the fluid over the period of time is not a leak. If such an indication is received, then the rate of the flow of the fluid over the period of time is stored in the list of events.

In accordance with another embodiment, the present invention relates to a system for detecting a leak in a conduit. A rate of flow of a fluid through the conduit is determined by a flowmeter. A system controller monitors the rate of flow of the fluid through the conduit over a period of time and compares the rate of flow over the period of time with a list of events. If the rate of flow of the fluid over the period of time does not match one of the events on the list of events, then the system controller sends a signal to stop the flow of fluid.

In response to the signal from the system controller, a valve stops the flow of the fluid through the conduit. After the flow is stopped, a pressure sensor determines a pressure in the conduit. The system controller monitors the pressure in the conduit and compares the pressure with a pressure in the conduit when the conduit is closed. If the pressure in the conduit is less than the pressure in the conduit when the conduit is closed, then the system controller provides an indication that a leak has been detected.

These and various other features as well as advantages, which characterize the present invention, will be apparent from a reading of the following detailed description and a review of the associated drawings.

### BRIEF DESCRIPTION OF THE DRAWINGS

FIG. 1 is a block diagram of a system for detecting and preventing a fluid leak according to an embodiment of the present invention.

FIGS. 2A-2C are flow diagrams showing an illustrative process for detecting and preventing a fluid leak according to an embodiment of the present invention.

### DETAILED DESCRIPTION OF THE PREFERRED EMBODIMENT

Embodiments of the present invention provide for systems and methods for detecting unwanted fluid flow through a conduit and stopping the unwanted fluid flow. When an unwanted fluid flow is detected, action is taken to stop the unwanted fluid flow and verify the existence of a leak or component failure in a pipe system. In the following detailed description, references are made to the accompanying drawings that form a part hereof, and in which are shown by way of illustration specific embodiments or examples. It should be understood that although the following description will be with respect to water flowing through water pipes in a structure, such as a home or building, the invention may be used to determine and prevent leakage of any fluid through pipes in any appropriate environment. Referring now to the drawings, in which like numerals represent like elements through the several figures, aspects of the present invention and the exemplary operating environment will be described.

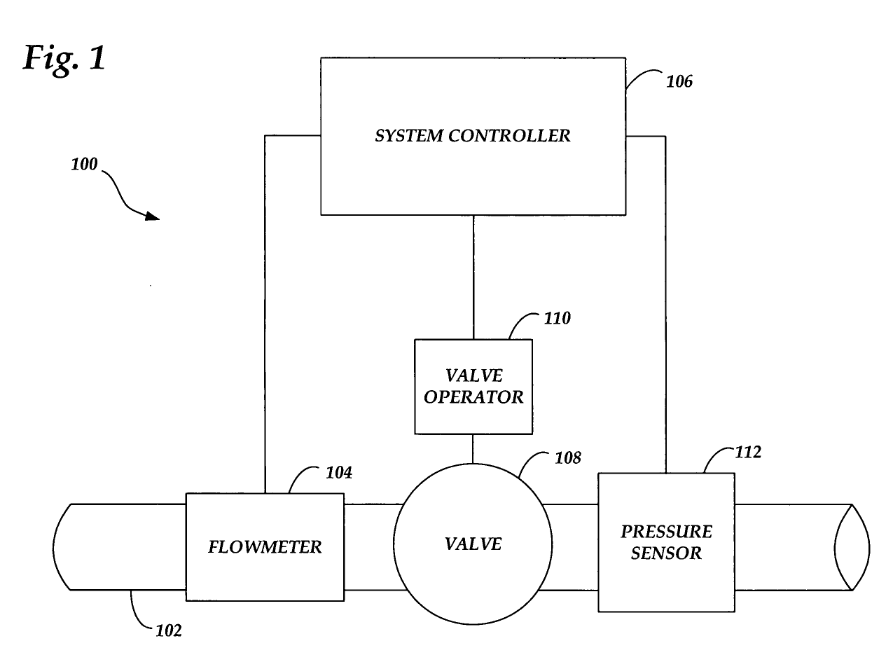

FIG. 1 is a block diagram of a system 100 for detecting and preventing water leaks including a flowmeter 104 connected to a water pipe 102 preferably downstream of a water supply pipe entry into a structure, such as a home. The flowmeter 104 may be of any suitable construction capable of measuring a rate of flow of a fluid flowing through the water pipe 102 and providing output data related to the rate of flow of the fluid to a system controller 106. Examples of other suitable devices include a rotating paddle wheel, a rotometer, an ultrasonic transducer, a differential pressure transducer, or any other known device for measuring a rate of flow of a fluid and providing output data related to the measured rate of flow.

The system 100 further includes a flow control device 108 connected to the water pipe 102. In an actual embodiment of the present invention, the flow control device 108 comprises a valve disposed downstream from the flowmeter 104. Alternatively, the flow control device 108 may be connected to the water pipe 102 upstream from the flowmeter 104. It should be understood that the flow control device 108 may be any suitable construction capable of stopping the flow of a fluid through the water pipe 102 in response to a signal communicated from the system controller 106. As later described, when the system controller 106 detects a leak in the water pipe 102, the system controller sends a signal to a valve operator 110 to close the flow control device 108 to prevent further flow through the water pipe.

A pressure sensor 112 is connected to the water pipe 102 downstream from the flow control device 108. The pressure sensor 112 may include any device operative to measure the pressure in the water pipe 102 and provide output data related to the pressure in the water pipe to the system controller 106. Examples of suitable devices include a strain gauge pressure sensor, a variable capacitance pressure sensor, a piezoelectric pressure sensor, or any other known device capable of measuring pressure and providing output data related to the measured pressure.

The system controller 106 is connected to the flowmeter 104, the valve operator 110, and the pressure sensor 112 via data lines as illustrated in FIG. 1. The system controller 106 includes a memory device for storing preset events and supplemental events that are used by a processor of the system controller in combination with output data received from the flowmeter 104 and pressure sensor 112 to determine if a leak in the water pipe 102 has occurred, as will be described below. The system controller 106 further includes a control panel for receiving data input regarding a rate of flow of water over a period of time and providing indications that a leak has been detected.

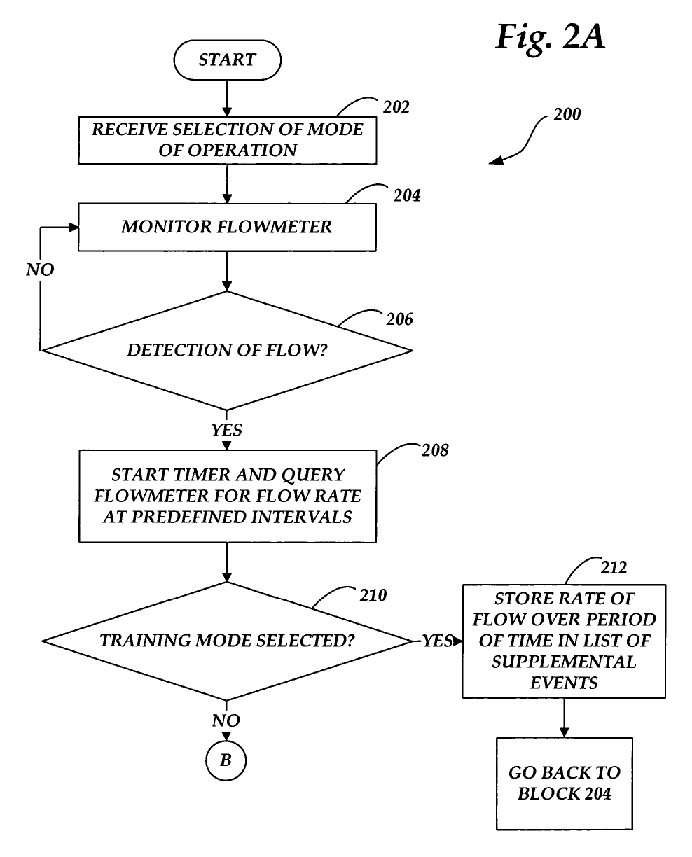

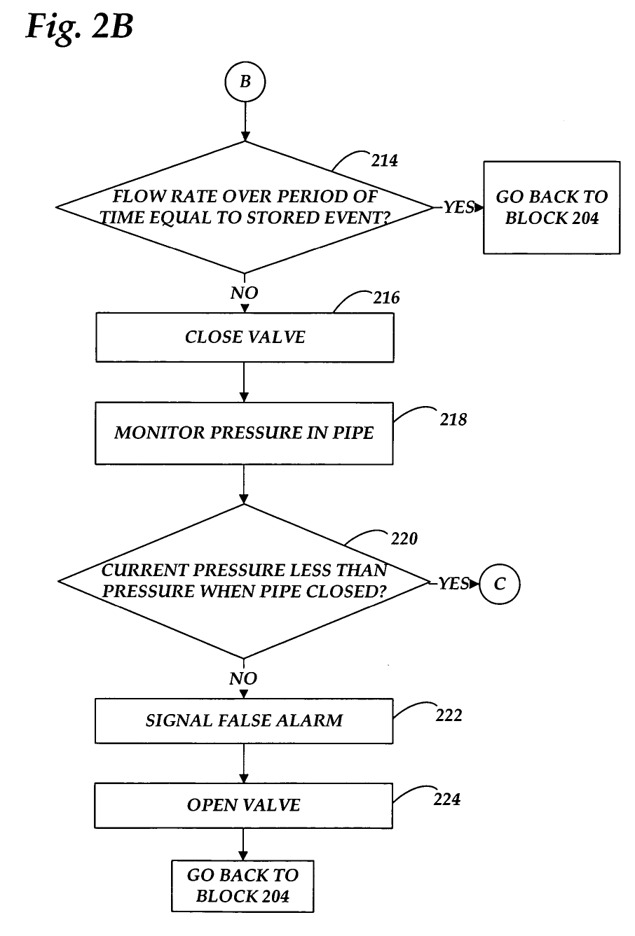

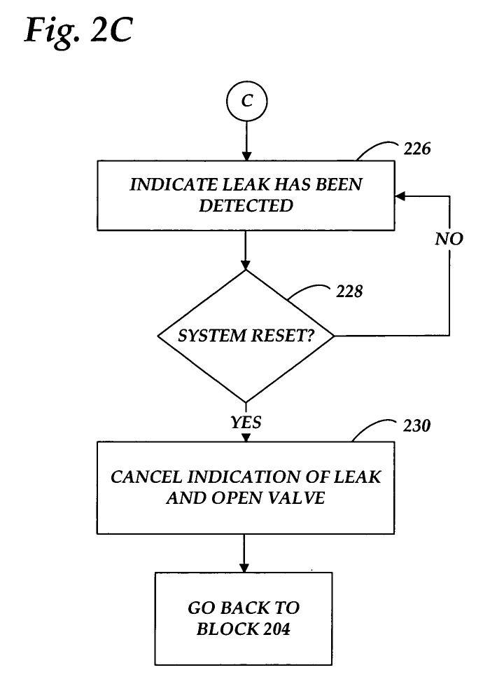

FIGS. 2A-2C illustrate a flowchart describing a process 200 for detecting and preventing a leak in a water pipe 102 of FIG. 1, according to an embodiment of the invention. The process 200 begins at block 202 where the system controller 106 receives a selection of a mode of operation. The system controller 106 includes various modes of operation which, when selected, allow for unique water consumption events, such as filling a pool or watering a lawn, without indicating that a leak has been detected. Each mode of operation is associated with a rate of flow of water over a period of time needed to complete that mode stored in the memory device of the system controller 106. For example, the mode of operation corresponding to filling a 3000-gallon pool is associated with a rate of flow of 3 gallons/minute over a period of 17 hours. The system controller 106 also includes a training mode which, when selected, indicates that the upcoming water consumption is a wanted consumption of water not currently stored in the list of events, as discussed further below. The control panel associated with the system controller 106 includes a set of light emitting diodes (LEDs) used to indicate which mode of operation has been selected.

From block 202, the process 200 proceeds to block 204, where the system controller 106 monitors the flowmeter 104 for a signal indicating that water is flowing through the water pipe 102. From block 204, the process proceeds to block 206 where the system controller 106 determines if the flowmeter 104 has sent a signal indicating a detection of flow through the pipe 102. When water is flowing through the water pipe 102, the flowmeter 104 detects the flow and sends an output signal to the system controller 106. If the system controller 106 has not received a signal from the flowmeter 104, then the process 200 proceeds back to block 204, where the system controller 106 continues to monitor the flowmeter 104. If, on the other hand, the system controller 106 has received a signal from the flowmeter 104, then the process proceeds to block 208, where the system controller 106 starts an internal timer and queries the flowmeter 104 for the rate of flow of the water through the water pipe 102 at predefined intervals such as, for example, every 15 seconds.

In another embodiment of the present invention, the system controller 106 may monitor the pressure sensor 112 to determine if water is flowing through the water pipe 102. When a faucet connected to the water pipe 102 is on or when a leak is present in the water pipe, water flows through the water pipe. When water is flowing through the water pipe 102, the pressure in the water pipe drops, causing the pressure sensor 112 to send an output signal related to the current pressure in the water pipe to the system controller 106.

If the system controller receives a signal from the pressure sensor 112, then the processor of the system controller 106 compares the current pressure in the water pipe 102 with the pressure in the water pipe when the water in the water pipe is not flowing, such as when the water pipe is closed, to determine if the current pressure is less than the pressure when the water is not flowing through the water pipe. If the current pressure is less than the pressure when water is not flowing through the water pipe 102, then the system controller 106 starts an internal timer and queries the flowmeter 104 for the rate of flow of the water through the water pipe 102 at predefined intervals, similar to the process 200 at block 208.

At block 208, the system controller 106 starts an internal timer and queries the flowmeter 104 for the rate of flow of the water through the water pipe 102 at predefined intervals. The system controller 106 continues to query the flowmeter 104 for the rate of flow of the water over a period of time and stores the values received from the flowmeter in the memory device associated with the system controller. From block 208, the process 200 proceeds to block 210, where a determination is made whether the training mode was selected. As discussed above, selection of the training mode indicates that the upcoming water consumption is a wanted consumption of water not currently stored in the list of events. If, at block 210, a determination is made that the training mode has been selected, then the process 200 proceeds to block 212, where the flow rate of the water over the period of time is stored in a list of supplemental events of water consumption events. After the flow rate of the water over the period of time is stored in the list of supplemental events, future flow rates of water over periods of time are compared to the events stored in the list of events as well as in the list of supplemental events. By using the supplemental events, the system 100 is able to more accurately determine a wanted water consumption event from an unwanted water consumption event for a particular residence. From block 212, the process 200 proceeds back to block 204, where the system controller 106 continues to monitor the flowmeter 104.

If, at block 210, a determination is made that the training mode has not been selected, then the process 200 proceeds to block 214, where a determination is made whether the rate of flow of the water over the period of time is equal to a stored event. The memory device of the system controller 106 includes a list of preset water consumption events that commonly occur inside a home as well as a list of supplemental events, as later described. For example, the list of events may include washing clothes, washing dishes, taking a shower, taking a bath, flushing a toilet, and any other water consumption event that commonly occurs inside a home or other structure. Each event on the list of events is associated with a rate of flow of water over a period of time typically needed to complete that event. For example, filling a toilet with water after it is flushed may be associated with a rate of flow of 1.5 gallons/minute for 15 seconds. The memory device of the system controller 106 also includes the rate of flow of water over the period of time associated with each mode of operation, as discussed above. At block 210, the processor of the system controller 106 compares the rate of flow of the water over the period of time with the rate of flow of water over the period of time associated with each event in the list of events as well as the rate of flow of water over the period of time associated with the selected mode of operation to determine if the rate of flow of water over the period of time is equal to the rate of flow of water over the period of time associated with one of the events. If the values are equal, then the current rate of flow of water over the period of time is considered a wanted water consumption event, and the process 200 proceeds to back to block 204, where the system controller 106 continues to monitor the pressure sensor 112. However, if a determination is made that the values are not equal, then the process 200 proceeds to block 216.

At block 216, since the system controller 106 has determined that an unwanted water consumption event has occurred, then the system controller sends a signal to the valve operator 110 instructing the valve operator to close the flow control device 108 so that further unwanted flow of water through the water pipe 102 is prevented. Once the flow control device 108 is closed, the process 200 proceeds to block 218, where the system controller 106 monitors the pressure in the water pipe 102 to verify that the unwanted flow of water detected is a leak. From block 218, the process 200 proceeds to block 220, where the processor of the system controller 106 compares the current pressure in the water pipe 102 with the pressure in the water pipe when the water in the water pipe is not flowing, such as when the water pipe is closed, to determine if the current pressure is less than the pressure when the water is not flowing through the water pipe. If the current pressure is less than the pressure when water is not flowing through the water pipe 102, then the process 200 proceeds to block 226. If, at block 220, a determination is made that the current pressure is not less than the pressure when the water is not flowing through the water pipe 102, then the process 200 proceeds to block 222, where the control panel associated with the system controller 106 provides an indication of a false alarm. The control panel associated with the system controller 106 includes a set of LEDs used to indicate the current status of the system 100. From block 222, the process 200 proceeds to block 224, where the system controller 106 sends a signal to the valve operator 110 to open the flow control device 108, and then the process 200 proceeds back to block 204, where the system controller 106 continues to monitor the flowmeter 104.

At block 226, where the system controller 106 provides an indication that a leak in the water pipe 102 has been detected. The system controller 106 uses the system status LEDs to indicate that a leak has been detected. The system controller 106 also provides an audible alert that will sound continuously for a predetermined amount of time, and if the system 100 is not manually reset by the conclusion of that predetermined amount of time, then the system controller 106 will sound the audible alert once every hour until the system is reset.

From block 226, the process 200 proceeds to block 228, where a determination is made whether the system 100 has been reset. If the system 100 has not been reset, then the process 200 proceeds back to block 226, where the audible alert continues to sound until the system is reset. If, at block 228, a determination is made that the system has been reset, then the process 200 proceeds to block 230 where indications that a leak has been detected are canceled, and the flow control device 108 is opened. The process 200 then proceeds back to block 204, where the system controller 106 continues to monitor the flowmeter 104.

In another embodiment of the present invention, the system 100 may actively seek out leaks in a pipe system associated with the water pipe 102 by periodically sending a signal instructing the valve operator 110 to close the flow control device 108. After the flow control device 108 closes, the system controller 106 signals the pressure sensor 112 to provide the pressure in the water pipe 102. The system controller 106 stores the current pressure in the memory device. After a predetermined amount of time, such as one minute, the system controller 106 signals the pressure sensor 112 to provide the pressure in the water pipe 102. The system controller 106 then compares the first pressure value received after the flow control device 108 is closed with the second pressure value received one minute after the flow control device is closed. If the values are the same, then the system controller 106 signals the valve operator 110 to open the flow control device 108. However, if the system controller 106 determines that the second pressure value is less than the first pressure value, then the system controller 106 provides an indication that a leak in the water pipe 102 has been detected. In an alternative embodiment, the system controller 106 signals the pressure sensor to provide the pressure in the water pipe 102, and the system controller 106 compares the current pressure with a stored pressure measurement taken when no water was flowing through the pipe 102. If the values are the same, then the system controller 106 signals the valve operator 110 to open the flow control device 108. However, if the current pressure is less than the stored pressure measurement, then the system controller 106 provides an indication that a leak in the water pipe 102 has been detected.

We claim:

1. A method for detecting a leak in a conduit, comprising:
monitoring a rate of flow of a fluid through the conduit over a period of time;
determining if the rate of flow of the fluid over the period of time indicates a leak in the conduit;
if the rate of flow of the fluid over the period of time indicates a leak in the conduit, then stopping the flow of the fluid through the conduit;
after stopping the flow of the fluid through the conduit, monitoring a pressure in the conduit;
determining if the pressure in the conduit indicates a pressure drop in the conduit; and
if the pressure in the conduit indicates a pressure drop in the conduit, then providing an indication that a leak has been detected.

2. The method of claim 1, wherein determining if the rate of flow of the fluid over the period of time indicates a leak in the conduit comprises:
comparing the rate of flow of the fluid over the period of time to a list of events; and
if the rate of flow of the fluid over the period of time does not match one of the events on the list of events, then stopping the flow of the fluid through the conduit.

3. The method of claim 2, wherein the list of events includes a rate of flow of a fluid over a period of time corresponding to a water consumption event.

4. The method of claim 3, wherein the water consumption event includes at least one of the following: washing clothes, washing dishes, taking a shower, taking a bath, and flushing a toilet.

5. The method of claim 1, wherein determining if the rate of flow of the fluid over the period of time indicates a leak in the conduit comprises:
receiving a selection of an operation mode, wherein the operation mode corresponds to a rate of flow of a fluid over a period of time;
comparing the rate of flow of the fluid over the period of time with a list of events;
if the rate of flow of the fluid over the period of time does not match one of the events in the list of events, then comparing the rate of flow of the fluid over the period of time with the rate of flow of the fluid over the period of time corresponding to the selected operation mode; and
if the rate of flow of the fluid over the period of time is not equal to the rate of flow of the fluid over the period of time corresponding to the selected operation mode, then stopping the flow of the fluid through the conduit.

6. The method of claim 4, wherein the operation mode includes filling a pool.

7. The method of claim 1, wherein determining if the pressure in the conduit indicates a pressure drop in the conduit further comprises:
comparing the pressure in the conduit with a pressure in the conduit when the conduit is closed; and
if the pressure in the conduit is less than the pressure in the conduit when the conduit is closed, then providing the indication that a leak has been detected.

8. The method of claim 1, wherein stopping the flow of the fluid through the conduit includes sending a signal to a valve connected to the conduit, wherein the signal instructs the valve to close.

9. The method of claim 1, wherein the indication that a leak has been detected includes an audible alert that continues until the audible alert is acknowledged.

10. The method of claim 1, further comprising:
receiving an indication that the rate of flow of the fluid over the period of time is not a leak; and
storing the rate of flow of the fluid over the period of time in the list of events.

11. A system for detecting a leak in a conduit, comprising:
means for determining a rate of flow of a fluid through the conduit;
control means for:
monitoring the rate of flow of the fluid over a period of time; and
determining if the rate of flow of the fluid over the period of time indicates a leak in the conduit;
means for stopping the flow of the fluid through the conduit if the rate of flow of the fluid over the period of time indicates a leak in the conduit;
means for determining a pressure in the conduit after the flow of the fluid through the conduit is stopped; and
the control means for:
monitoring the pressure in the conduit;
determining if the pressure in the conduit indicates a pressure drop in the conduit; and
providing an indication that a leak has been detected if the pressure in the conduit indicates a pressure drop in the conduit.

12. The system of claim 11, wherein the means for determining a rate of flow of a fluid through the conduit includes a flowmeter.

13. The system of claim 11, wherein the control means includes a system controller comprising a memory device, a processor functionally connected to the memory device, and a control panel.

14. The system of claim 11, wherein the means for stopping the flow of the fluid through the conduit includes a valve.

15. The system of claim 11, wherein the means for determining a pressure in the conduit includes a pressure sensor disposed downstream from the means for stopping the flow of the fluid through the conduit.

16. The system of claim 11, wherein the indication that a leak has been detected includes an audible alert that continues until the audible alert has been acknowledged.

17. A system for detecting a leak in a conduit, comprising:
a flowmeter operative to determine a rate of flow of a fluid through the conduit;
a system controller operative to:
monitor the rate of flow of the fluid through the conduit over a period of time;
compare the rate of flow of the fluid over the period of time with a list of events; and
if the rate of flow of the fluid over the period of time does not match one of the events on the list of events, then send a signal to stop the flow of the fluid though the conduit;
a valve operative to stop the flow of the fluid through the conduit in response to the signal from the system controller;
a pressure sensor operative to determine a pressure in the conduit after the flow of the fluid through the conduit is stopped;
the system controller further operative to:
monitor the pressure in the conduit after the flow of the fluid through the conduit is stopped;
compare the pressure in the conduit with a pressure in the conduit when the conduit is closed; and
provide an indication that a leak has been detected if the pressure in the conduit is less than the pressure in the conduit when the conduit is closed.

18. The system of claim 17, wherein the list of events includes a rate of flow of a fluid over a period of time corresponding to at least one of the following events: washing clothes, washing dishes, taking a shower, taking a bath, and flushing a toilet.

19. The system of claim 17, wherein the system controller is further operative to:
receive a selection of an operation mode, wherein the operation mode corresponds to a rate of flow of a fluid over a period of time;
compare the rate of flow of the fluid over the period of time with the rate of flow of the fluid over the period of time corresponding to the selected operation mode;
if the rate of flow of the fluid over the period of time is not equal to the rate of flow of the fluid over the period of time corresponding to the selected operation mode, then compare the rate of flow of the fluid over the period of time with a list of events; and
if the rate of flow of the fluid over the period of time does not match one of the events in the list of events, then send a signal to stop the flow of the fluid.

20. The system of claim 17, wherein the system controller is further operative to:
receive an indication that the rate of flow of the fluid over the period of time is not a leak; and
store the rate of flow of the fluid over the period of time in the list of events.
